(19) United States
(12) Patent Application Publication
(10) Pub. No.: US 2005/0089092 A1
(43) Pub. Date: Apr. 28, 2005

(54) Moving picture encoding apparatus

(76) Inventors: Yasuhiro Hashimoto, Tokyo (JP); Masatoshi Takashima, Tokyo (JP); Daisuke Hiranaka, Kanagawa (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 10/691,419

(22) Filed: Oct. 22, 2003

(51) Int. Cl. H04N 7/12

(52) U.S. Cl. 375/240.03; 375/240.01; 375/240.18

(57) ABSTRACT

A moving picture encoding apparatus in which a minimum picture quality may be maintained even though the bitrate of an output encoded datastream is changed. A real-time distribution system for moving pictures 1 includes a frame rate conversion unit 11 for controlling the frame rate of input moving picture data, an encoding unit 12 for encoding moving picture data, having a controlled frame rate, in accordance with the MPEG-4, a frame rate calculating unit 16 for calculating a setting value of the frame rate, a transmission unit 13 for transmitting/receiving data over a network, and a receiving unit 14. The receiving unit 14 detects the state of communication on the network and, based on the detected state of communication on the network, calculates a target bitrate. The encoding unit 12 controls the bitrate of the MPEG-4 datastream responsive to this target bitrate. The frame rate calculating unit 16 estimates the picture quality based on the quantization scale of the encoding unit 12 and, in case of deterioration of the picture quality to more than a preset level, lowers the frame rate.

### BACKGROUND OF THE INVENTION

1. Field of the Invention

This invention relates to a moving picture encoding apparatus and method for generating a moving picture datastream, distributed in real-time over a network, and to a moving picture transmitting apparatus for transmitting the moving picture datastream.

2. Description of Related Art

Recently, a system for real-time distribution of moving picture data by exploiting a network, such as the Internet, is becoming popular. In such real-tine distribution system, the transmission rate is adaptively changed on the transmitting side, in keeping up with the state of communication on the network, in order to cope with changes in the state of communication on the network with lapse of time, such as to assure up-to-date characteristics (see for example the Cited reference 1).

For real-time distribution of moving picture data, using an IP network, such as the Internet, the RTP (Real-Time Transport Protocol) and RTCP (Real-Time Transport Control Protocol), standardized in RFC1889/1890, is applied. The RTP is the data transmission protocol for transmitting real-time data, such as moving picture data, from a transmitting side to a receiving side, while the RTCP is a data transmission protocol for transmitting the control information for data transmitted in accordance with the RTP.

In performing real-time distribution, employing RTP and RTCP, the rate of RTP packets lost on the network (packet loss ratio) or the delay time (jitter) of the RTP packet received by the receiving apparatus, is included in the RTCP packet and transmitted from the receiving apparatus to the transmitting apparatus. Thus, when the packet loss ratio or the jitter is increased, the transmitting apparatus determines that the transmission efficiency of the network is lowered and thus lowers the data transmission rate. When the packet loss ratio or the jitter is decreased, the transmitting apparatus determines that the transmission efficiency of the network is raised and thus raises the data transmission rate. Thus, with the RTP and the RTCP, it is possible for the transmitting apparatus to change the transmission rate adaptively in keeping up with the status on the network to allow distribution of moving picture data as up-to-date characteristics for the data being distributed is assured.

Cited Reference 1

Japanese Laying-Open Patent Publication H11-308271
   Cited Reference 2
Japanese Laying-Open Patent Publication 2002-199398

Meanwhile, in encoding moving picture data for real-time distribution, the MPEG (Moving Picture Coding Experts Group)-1, -2 or -4 is generally employed. With the moving picture encoding system, such as MPEG-1, -2 or -4, the bitrate of an output datastream is controlled by varying the quantization scale at the time of quantization processing. Specifically, the bitrate of an output datastream is decreased by increasing the quantization scale, thereby lowering the bitrate of the output datastream, while the bitrate of the output datastream is increased by decreasing the quantization scale, thereby raising the bitrate of the output datastream.

Thus, if, in real-time distribution of a datastream, generated in accordance with the moving picture encoding system, such as MPEG-1, -2 or -4, the rate of transmission is to be adaptively changed on the transmitting apparatus, in dependence on the state of communication on the network, it is sufficient to control the quantization scale at the time of the encoding.

However, if the quantization scale is increased, the picture quality of the frame is concomitantly deteriorated, such that, depending on the picture contents, the minimum picture quality may not be assured.

There is also known a moving picture encoding apparatus for controlling the picture quality by controlling the frame rate (see for example the Cited Reference 2). In such moving picture encoding apparatus, since the frame rate is controlled by exploiting the features of the moving picture prior to encoding, it is not possible to control the frame rate depending on the current status on the network to assure up-to-data characteristics.

### SUMMARY OF THE INVENTION

In view of the above depicted status of the art, it is an object of the present invention to provide an apparatus and a method for encoding moving pictures and an apparatus for transmitting moving pictures whereby it is possible to assure the minimum picture quality even when the bitrate of the encoded datastream to be output is changed.

In one aspect, the present invention provides an apparatus for encoding a moving picture comprising frame rate controlling means for controlling the frame rate of an input moving picture datastream, composed of a plurality of chronologically arrayed frames, frame rate calculating means for calculating a setting value of the frame rate of the moving picture datastream, and encoding means for encoding the moving picture datastream, output from the frame rate controlling means, for compression, and for outputting an encoded datastream, generated on the encoding for compression. The encoding means controls the bitrate of the encoded datastream in dependence on a target bitrate as set from outside, while the frame rate calculating means calculates a setting value of the frame rate based on the picture quality of the encoded datastream output from the encoding means. The frame rate controlling means controls the frame rate of the moving picture datastream to a setting value calculated by the frame rate calculating means.

With the above-described moving picture encoding apparatus, the bitrate of the encoded datastream is controlled based on the target bitrate as set from outside, while the frame rate of the moving picture datastream is changed to a frame rate calculated on the basis of the picture quality of the encoded datastream.

In another aspect, the present invention provides a method for encoding a moving picture in which an input moving picture datastream, composed of a plurality of chronologically arrayed frames, is encoded for compression to generate an encoded datastream. The method comprises encoding the datastream for compression, as the bitrate of encoded datastream to be output is controlled in keeping with a target bitrate as set, detecting the picture quality of the generated encoded datastream and calculating the setting value of the frame rate based on the detected picture quality, by way of controlling the frame rate of the moving picture datastream.

With the above-described moving picture encoding method, the bitrate of the encoded datastream is controlled based on the target bitrate set from outside, while the frame rate of the moving picture datastream is changed to a frame rate calculated on the basis of the picture quality of the encoded datastream.

In yet another aspect, the present invention provides an apparatus for transmitting a moving picture comprising frame rate controlling means for controlling the frame rate of an input moving picture datastream composed of a plurality of chronologically arrayed frames, frame rate calculating means for calculating a setting value of the frame rate of the moving picture datastream, encoding means for encoding the moving picture datastream, output from the frame rate controlling means, for compression, and for outputting an encoded datastream, generated on the encoding for compression, and transmitting/receiving means for transmitting the datastream, encoded by the encoding means, to a receiving apparatus over a network, and transmitting/receiving control data with the receiving apparatus. The transmitting/receiving means detects the state of the network based on control data received by the receiving apparatus and calculates a target bitrate based on the detected network status. The encoding means controls the bitrate of the encoded datastream responsive to the target bitrate calculated by the transmitting/receiving means. The frame rate calculating means calculates the setting value of the frame rate based on the picture quality of the encoded datastream output from the encoding means. The frame rate controlling means controls the frame rate of the moving picture datastream to the setting value calculated by the frame rate calculating means. In the above-described moving picture transmitting apparatus, the bitrate of the encoded datastream is controlled responsive to the target bitrate determined responsive to the status of the network, such that the bitrate-controlled encoded datastream is transmitted on the network, whilst the frame rate of the moving picture datastream is changed to a frame rate calculated on the basis of the picture quality of the encoded datastream.

With the moving picture encoding method and apparatus according to the present invention, the encoded datastream is output-as the bitrate of the encoded datastream is controlled in dependence on the target bitrate as set from outside, whilst the frame rate of the moving picture datastream is changed to the frame rate calculated on the basis of the picture quality of the encoded datastream.

Thus, with the moving picture encoding method and apparatus according to the present invention, the moving picture may be encoded as the minimum picture quality is assured, even when the bitrate of the output encoded datastream is changed.

With the moving picture transmitting apparatus according to the present invention, the bitrate of the moving picture datastream is controlled in dependence on the target bitrate, as determined responsive to the status on the network, and the bitrate-controlled encoded datastream is transmitted to the network, whilst the frame rate of the moving picture datastream is changed to the frame rate calculated on the basis of the encoded datastream.

Thus, with the moving picture transmitting apparatus according to the present invention, the moving picture may be encoded in a manner of assuring the minimum picture quality even if the bitrate of the output encoded datastream is changed.

### BRIEF DESCRIPTION OF THE DRAWINGS

FIG. 1 is a schematic block diagram showing a real-time distribution system for moving picture data according to an embodiment of the present invention.

FIGS. 2A and 2B show a data structure of baseband moving picture data and a data structure of the moving picture data following frame rate conversion.

FIG. 3 is a schematic block diagram showing an encoding unit for moving pictures in a transmission apparatus.

FIG. 4 shows a table stating target frame rates.

FIG. 5 is a flowchart showing the processing flow in calculating the frame rates.

FIGS. 6A to 6E show a specified instance of processing operations of a transmission apparatus in case of executing frame rate controlling processing.

FIG. 7 is a block diagram of a moving picture encoding unit provided with an S/N ratio calculating circuit.

### DESCRIPTION OF THE PREFERRED EMBODIMENTS

A real-time distribution system of moving picture data, embodying the present invention, is now explained by way of illustrating an embodiment of the present invention.

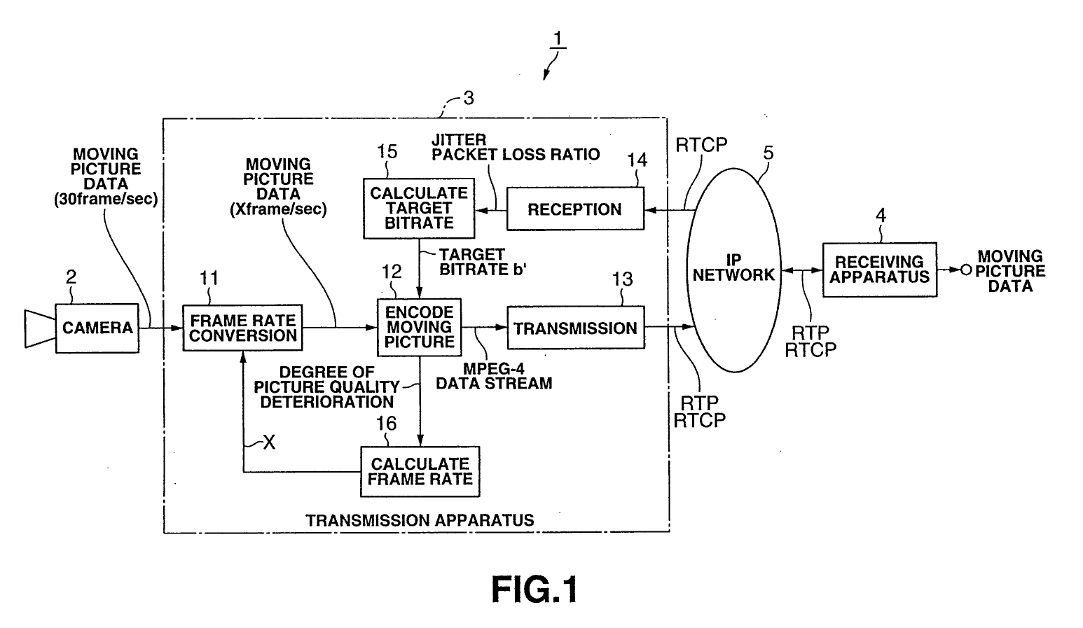

FIG. 1 shows the structure of a real-time distribution system of moving picture data embodying the present invention.

Referring to FIG. 1, the real-time distribution system 1, embodying the present invention, is made up by a transmission device 3, a receiving device 4 and an IP network 5.

In the real-time distribution system 1, the transmission device 3 encodes moving picture data, output from e.g. a camera device 2, in accordance with the MPEG-4 (ISO/IEC 14496-2) standard system, to generate an MPEG-4 datastream. The transmission device 3 converts the MPEG-4 datastream into an RTP packet and further converts the RTP packet to a UDP packet added by an IP header. The moving picture data, packetized to an IP packet by the transmission device 3, is transmitted to the receiving device 4 over an IP network 5 as a network to which is applied the Internet protocol. The receiving device 4 receives the IP packet, transmitted from the transmission device 3, and extracts MPEG-4 data from the IP packet to decode moving picture data.

Moreover, in the real-time distribution system 1, the control information for the RTP packet is packetized into an RTCP packet so as to be exchanged between the transmission device 3 and the receiving device 4. The RTCP packet is packetized to a TCP packet, added by an IP header, so as to be distributed to the network 5.

The receiving device 4 transmits RTCP packet to the transmission device 3 as e.g. the jitter and the packet loss ratio of the RTP packet, contained in the moving picture data, are included in the RTCP packet as a parameter indicating the state of the IP network 5. The transmission device 3 then verifies the state of communication currently going on over the IP network 5, based on the jitter or the packet loss ratio, received from the receiving device 4, to control the bit rate of the MPEG-4 bitstream, such as to assure real-time distribution. For example, the transmission device 3 controls the bitrate of the MPEG-4 bitstream, so that, when it is determined that the jitter or the packet loss ratio is increased such that the state of communication on the network 5 has become worsened, the bitrate of the MPEG-4 bitstream is lowered to lower the transmission rate, whereas, when it is determined that the jitter or the packet loss ratio is decreased such that the state of communication on the network 5 has become better, the bitrate is raised to increase the transmission rate.

Thus, with the real-time distribution system 1, the moving picture data output from e.g. the camera device 2 may be transmitted in real-time to the receiving device 4 even on the occasion of variations in the state of communication of the IP network 5.

The structure of the transmission device 3 is now explained in detail.

The transmission device 3 includes a frame rate conversion unit 11 for converting the frame rate of the moving picture data, transmitted from the camera device 2, a moving picture encoding unit 12 for encoding the moving picture data, output from the frame rate conversion unit 11, in accordance with the MPEG-4 system, by way of compression, a transmission unit 13 for packetizing an MPEG-4 data stream, generated by the moving picture encoding unit 12 and other information to transmit the packetized MPEG-4 data stream and the packetized information over the IP network 5 to the receiving device 4, and a receiving unit 14 for receiving the packet transmitted from the receiving device 4 over the IP network 5. The transmission device 3 also includes a target rate calculating unit 15 for calculating the target bitrate of the MPEG-4 bitstream generated by the moving picture encoding unit 12, and a frame rate calculating unit 16 for calculating the target frame rate of the moving picture data generated by the frame rate conversion unit 11.

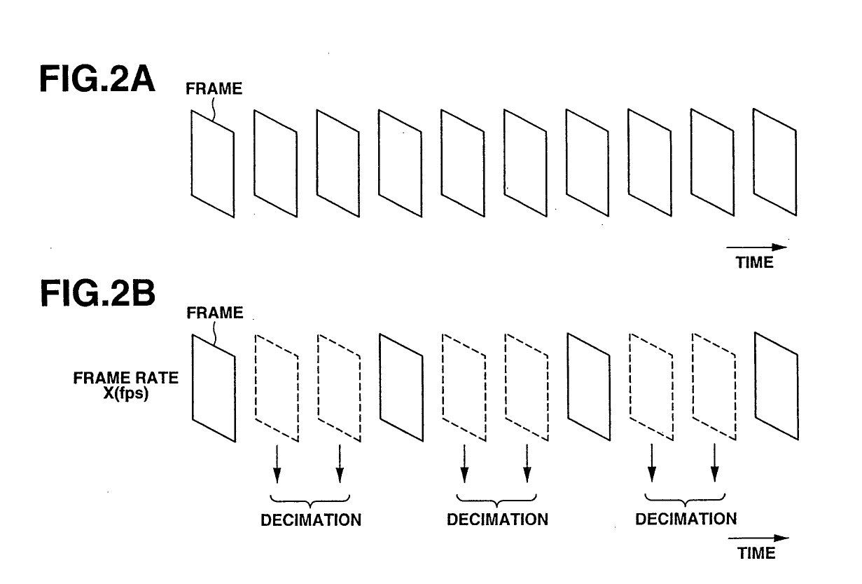

The frame rate conversion unit 11 is supplied with baseband moving picture data from the camera device 2. The baseband moving picture data, output from the camera device 2, is of such a data structure in which rectangular frames of a predetermined picture size are arrayed chronologically at a predetermined time interval, as shown in FIG. 2A. Meanwhile, the number of frames per second is termed the frame rate. The frame rate conversion unit 11 is supplied with a target frame rate (Xfps) from the frame rate calculating unit 16. The frame rate conversion unit 11 executes frame decimating processing on the input baseband moving picture data to generate baseband moving picture data of X (fps), as shown in FIG. 2B. The baseband moving picture data of X (fps), generated by the frame rate conversion unit 11, are supplied to the moving picture encoding unit 12. If need be, the frame rate conversion unit 11 converts the frame size of the output baseband moving picture data so as to be in meeting with the input picture format of MPEG-4.

The moving picture encoding unit 12 is supplied with baseband moving picture data of X (fps) output from the frame rate conversion unit 11. The moving picture encoding unit 12 encodes the input baseband moving picture data for compression in accordance with the MPEG-4 system to generate an MPEG-4 datastream. The MPEG-4 datastream, generated by the moving picture encoding unit 12, is supplied to the transmission unit 13. The moving picture encoding unit 12 is also supplied with a target bitrate b′. (bit per second) from the target rate calculating unit 15. The moving picture encoding unit 12 is supplied with the target bitrate b′ (bit per second) from the target rate calculating unit 15. The moving picture encoding unit 12 performs encoding processing for compression, as it controls the quantization scale (q_scale), in order that the bitrate of the generated MPEG-4 datastream will be equal to the aforementioned target bitrate b′. The structure of the moving picture encoding unit 12 will be explained in detail subsequently.

The transmission unit 13 is supplied with the MPEG-4 datastream output from the moving picture encoding unit 12. The transmission unit 13 packetizes the input MPEG-4 datastream into an RTP packet, and further packetizes this RTP packet into a UDP packet added by an IP header. The transmission unit 13 also packetizes the control information, adapted for controlling the transfer of the RTP packet, into an RTCP packet, and packetizes this RTCP packet into a TCP packet added by the IP header. The transmission unit 13 transmits the so generated IP packet over the IP network 5 to the receiving device 4.

The receiving unit 14 receives the RTCP packet, transmitted from the receiving device 4 via IP network 5. The receiving unit 14 extracts the control information contained in the received RTCP packet to send the so extracted control information to e.g. a controller, not shown. The receiving unit 14 also extracts various parameters, indicating the state of communication over the IP network 5, contained in the RTCP packet, transmitted from the receiving device 4, such as, for example, jitter or packet loss ratio, to supply the so extracted parameters to the target rate calculating unit 15.

The target rate calculating unit 15 is supplied from the receiving unit 14 with a large variety of parameters, such as jitter or packet loss ratio, indicating the state of communication on the IP network 5. The target rate calculating unit 15 estimates the state of communication on the IP network 5, at the current time point, based on the various input parameters, to calculate an optimum bitrate, at the current time point, of the MPEG-4 datastream generated by the moving picture encoding unit 12. That is, the target rate calculating unit 15 controls the target bitrate so that, when the state of communication on the network 5 is aggravated, the bitrate of the MPEG-4 datastream is lowered to lower the transmission rate and, when the state of communication on the network 5 is improved, the bitrate of the MPEG-4 datastream is raised to increase the transmission rate, thereby assuring real-time transmission.

For example, with the packet loss ratio of r, and the bitrate of the MPEG-4 datastream of the current time point of b, the target rate calculating unit 15 calculates the target bitrate b′ by for example the following equation (1):
b′=b×(1−r) (1).

This equation (1) means that, when there is any packet(s) not received by the receiving device 4, the bitrate is corrected in an amount corresponding to the packet loss ratio. Meanwhile, if the packet loss ratio is 0 or if the packet loss ratio r is not larger than a preset value, the target bitrate b′ may also be raised, under the assumption that there is an allowance in the rate of transmittable data.

The method for calculating the target bitrate is not limited to the method for calculating the target bitrate, shown in the equation (1), provided that the method allows for calculation of the optimum bitrate in dependence upon the prevailing state of communication on the IP network 5.

The frame rate calculating unit 16 acquires parameters, indicating the degree of deterioration of the picture quality, ascribable to the compression by the encoding, from the moving picture encoding unit 12. Here, the frame rate calculating unit acquires the quantization scale (q_scale), used for example in quantizing processing, as a parameter indicating the degree of picture quality deterioration, from the moving picture encoding unit 12. The frame rate calculating unit 16 calculates the target frame rate (X), to be accorded to the frame rate conversion unit 11, based on the so acquired degree of deterioration of the picture quality.

Specifically, when the degree of deterioration of the picture quality following the encoding for compression is not less than a first preset value, that is, if the quantization scale is not less than a first threshold value, the frame rate calculating unit 16 lowers the target frame rate to lower the frame rate of moving picture data supplied to the moving picture encoding unit 12. By lowering the frame rate in case the degree of deterioration of the picture quality is not less than the first threshold value, the respective frames may be improved in picture quality. That is, in case the bitrate is not changed before and after the lowering of the frame rate, the quantity of bits allocated to each frame is increased, so that the picture quality of the frame is improved. On the other hand, if the degree of deterioration of the picture quality after encoding for compression is not larger than the second threshold value, that is if the quantization scale is not larger than the second threshold value, the frame rate calculating unit 16 raises the target frame rate to increase the frame rate of the moving picture data supplied to the moving picture encoding unit 12. It is noted that the second threshold value is smaller than the first threshold value. In this manner, the respective pictures are lowered in picture quality by lowering the frame rate in case the degree of deterioration of the picture quality is not larger than the second threshold value. That is, in case the bitrate is not changed before and after the raising of the frame rate, the quantity of bits allocated to each frame is decreased, so that the picture quality of the frame is deteriorated. However, by decreasing the setting of the second threshold value to a sufficiently small value, it is possible to keep the picture quality to higher than a preset value. Thus, by raising the frame rate as a sufficient picture quality is maintained, picture continuity may be maintained as the picture quality is kept.

The specified processing for calculating the target frame rate by the frame rate calculating unit 16 will be explained in detail subsequently.

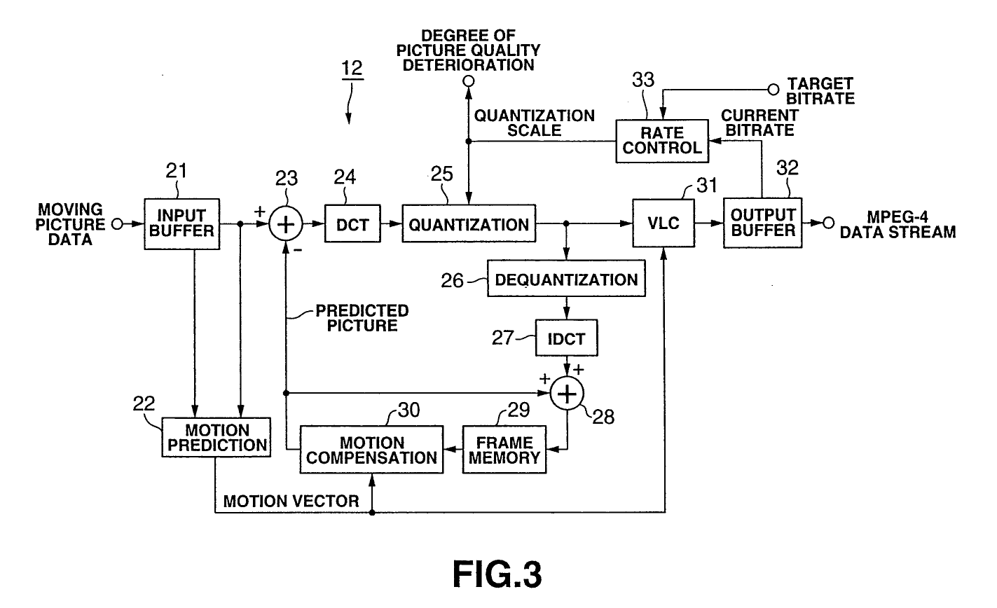

Referring to FIG. 3, the moving picture encoding unit 12 is now explained in detail.

In FIG. 3, the moving picture encoding unit 12 includes an input buffer 21, a motion prediction circuit 22, a first summation circuit 23, a discrete cosine transform (DCT) circuit 24, a quantization circuit 25, an inverse quantization circuit 26, an inverse discrete cosine transform (IDCT) circuit 27, a second summation circuit 28; a frame memory 29, a motion compensation circuit 30, a variable length encoding circuit 31, an output buffer 32 and a rate controlling circuit 33.

The input buffer 21 is supplied with moving picture data of a spatial area of X (fps), input from the frame rate conversion unit 11, to store the moving picture data transiently therein.

The motion prediction circuit 22 calculates the amount of movement in the temporal direction from the moving picture data stored in the input buffer 21 to generate the motion vector based on the amount of movement. The motion vector is calculated from one macro-block, constructed from 16×16 pixels, to another. The motion vector, calculated by the motion prediction circuit 22, is sent to the motion compensation circuit 30 and to the variable length encoding circuit 31.

The first summation circuit 23 is supplied with moving picture data from the input buffer 21 on the frame basis. If the encoding processing exploiting the frame-to-frame correlation is to be performed on picture data that is to be encoded, that is, if a picture being encoded is a P- or B-picture, the first summation circuit 23 is also supplied with the predicted picture data from the motion compensation circuit 30. If an inter-macro-block is to be processed, the first summation circuit 23 subtracts predicted picture data from the input picture data. If an intra-macro-block is to be processed, the first summation circuit 23 directly outputs the input picture data.

The DCT circuit 24 applies discrete cosine transform to the picture data output from the first summation circuit 23 to generate DCT coefficient data as picture data in the frequency domain. The DCT circuit 24 outputs the generated DCT coefficients to the quantization circuit 25.

The quantization circuit 25 applies quantization processing to the input DCT coefficient data, using the quantization scale supplied from the rate controlling circuit 33, to output quantized data.

The inverse quantization circuit 26 is supplied with data of a frame that may become reference picture data (DCT coefficient data of I- and P-picturers) among the quantized data output from the quantization circuit 25. The inverse quantization circuit 26 applies inverse quantization to the input quantized data by the quantization scale used in quantizing the quantized data.

The IDCT circuit 27 applies IDCT to the DCT coefficient data output from the inverse quantization circuit 26 to generate picture data of the spatial area.

The second summation circuit 28 is supplied with picture data output from the IDCT circuit 27. If the input picture data is a P-picture, predicted picture data of the picture data are input from the motion compensation circuit 30 to the second summation circuit 28. If the inter-macro-block is to be processed, the second summation circuit 28 sums the predicted picture data to the input picture data. If the intra-macro-block is to be processed, the second summation circuit 28 directly outputs the input picture data. The second summation circuit 28 causes the output picture data to be stored on the frame basis as reference picture data in the frame memory 29.

The reference picture data, output from the second summation circuit 28, is stored in the frame memory 29.

The motion compensation circuit 30 applies motion compensation to the reference picture data, stored in the frame memory 29, by having reference to the motion vector, to generate predicted picture data. The predicted picture data is supplied to the first summation circuit 23. Of the predicted picture data, the picture data which is to be the reference picture (predicted picture data of the P-picture) is also supplied to the second summation circuit 28.

The variable length encoding circuit 31 applies variable or fixed length encoding to the quantized data output from the quantization circuit 25, the motion vector output by the motion prediction circuit 22, and to a variety of control data supplied from a controller, not shown, to generate an encoded stream pursuant to the MPEG-4 standard (MPEG-4 datastream). The variable length encoding circuit 31 causes the generated MPEG-4 datastream to be stored in the output buffer 32.

The output buffer 32 causes the MPEG-4 datastream to be stored therein transiently and, in accordance with a readout command from the transmission unit 13 of a downstream side, transmits the data in needed quantities to the transmission unit 13.

The rate controlling circuit 33 is supplied with the target bitrate b′ from the target rate calculating unit 15. The rate controlling circuit 33 refers to the output buffer 32 to find bitrate b of the MPEG-4 datastream at the current time point. The rate controlling circuit 33 detects the difference between the target bitrate b′ and the current bitrate b to variably control the quantization scale (q_scale) so that the bitrate of the output. MPEG-4 datastream will be coincident with the target bitrate b′. That is, the rate controlling circuit 33 exercises control for reducing the quantization scale if the current bitrate b is larger than the target bitrate b′, while exercising control for increasing the quantization scale if the current bitrate b is smaller than the target bitrate b′.

With the moving picture encoding unit 12, the input moving picture data is encoded for compression in accordance with the MPEG-4 system to generate the MPEG-4 datastream. Additionally, with the present moving picture encoding unit 12, the bitrate of the output MPEG-4 datastream can be changed so as to follow up with the target bitrate b′ that is changed depending on the state of communication of the IP network 5.

Moreover, the present moving picture encoding unit 12 sends the quantization scale (q_scale) as the degree of deterioration of the picture quality to the frame rate calculating unit 16.

The specified frame rate calculating processing by the frame rate calculating unit 16 is hereinafter explained.

It is here assumed that the frame rate of the moving picture data output from the camera device 2 is 30 fps. It is also assumed that the moving picture encoding unit 12 is an encoder which is in meeting with the simple profile level 3 of MPEG-4 and that, in keeping up therewith, the maximum frame rate of the moving picture data output from the frame rate conversion unit 11 is 15 fps.

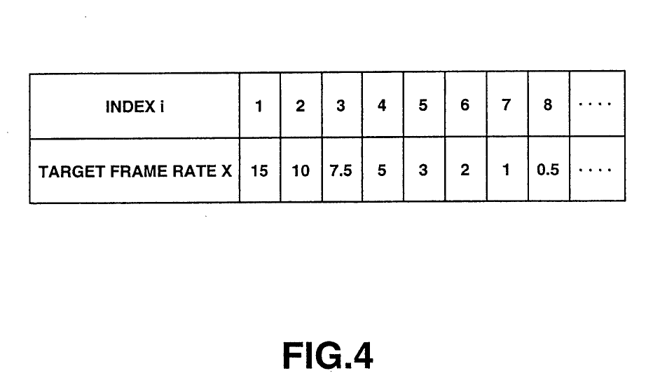

The frame rate calculating unit 16 holds a table stating a set of the values of the target frame rate X, to be set for the frame rate conversion unit 11, as shown in FIG. 4. For example, this table states target frame rates, such as 15 fps, 10 fps, 7.5 fps, 5 fps, 3 fps, 2 fps, 1 fps, 0.5 fps and so on. Additionally, there are set unique indices i to the respectively frame rates in the table. The indices i are set so that, when the values of the target frame rate are arrayed in the decreasing order, the indices i are incremented by one from “1”. For example, in the present embodiment, the index “1” is accorded to 15 fps, the index “2” is accorded to 10 fps and the the index “3” is accorded to 7.5 fps. It should be noted that the set of the target frame rates, held in the above table, is formed on the premises that post-conversion moving picture data are generated by periodically taking out the frames from the frames of the original moving picture data, such as by extracting one frame every two frames (15 fps), every three frames (10 fps) and every four frames (7.5 fps) of the moving picture data output from the camera device 2. However, any desirable method may be used for converting the frame rate. For example, characteristic frames may be taken out instead of taking out the frames periodically. In this case, the set of the frame rates held on the table is specific to the particular extraction method used.

In the above table, there is no target frame rate (6 fps), in case every fifth frame is taken out, in consideration that this target frame rate is close to the target frame rate (7.5 fps) in case every sixth frame is taken out (7.5 fps). By having no target frame rate for such case, it is possible to achieve efficient utilization of the memory and to render the amount of change constant.

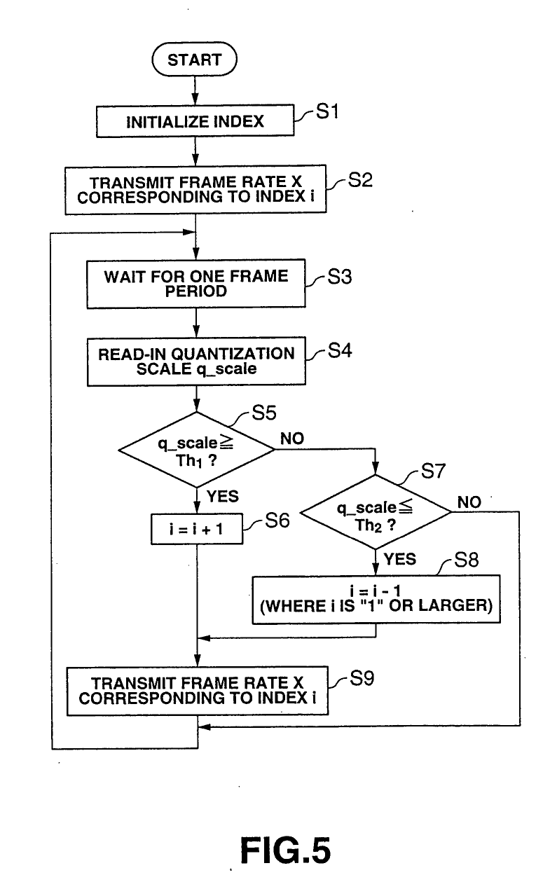

FIG. 5 depicts the flowchart for calculating the frame rate by the frame rate calculating unit 16. By referring to this flowchart for calculation, the processing for calculating the frame rate is now explained.

First, the frame rate calculating unit 16 initializes the index i to an appropriate value (step S1). The frame rate calculating unit 16 then acquires the target frame rate X, corresponding to the index i, by referring to the table shown in FIG. 4, and transmits the so acquired target frame rate to the frame rate conversion unit 11. The frame rate conversion unit 11 acquires the transmitted target frame rate X and sets it within itself. The frame rate conversion unit converts the frame rate of the moving picture data, supplied from the camera device 2, into the transmitted target frame rate X.

The frame rate calculating unit 16 withholds from performing the processing until the encoding processing for one frame comes to a close (step S3). The frame rate calculating unit 16 then reads-in the quantization scale from the moving picture encoding unit 12 (step S4). Meanwhile, the quantization scale differs from one macro-block to another. Consequently, the quantization scale, read-in from the moving picture encoding unit 12, is desirably the mean value of the quantization scale in one frame. However, for decreasing the processing volume, it is also possible to read-in vop_quant as the quantization scale of the initial macro-block of the frame.

The frame rate calculating unit 16 then compares the magnitude of the quantization scale as read-in to a first threshold value (Th1) to each other to see which is larger (step S5). Specifically, the larger the quantization scale, the more the picture quality is deteriorated. The first threshold value sets an upper limit value of the degree of deterioration of the picture quality by limiting the quantization at the quantization scale (q_scale) larger than this threshold value. In the case of the MPEG-4, the quantization scale assumes the value of from 1 to 31, while the first threshold value (Th1) is set to a value of e.g. “20”.

In case the quantization scale as read-in exceeds the first threshold value (Th1), that is in case the picture quality is deteriorated to more than a preset reference value, the frame rate calculating unit 16 increments the index by one (step S6). That is, the target frame rate is decreased by one step. By decreasing the target frame rate in this manner, the amount of bits allocated to one frame is increased, in case the bit rate is not changed, as a result of which the picture quality may be improved.

If the quantization scale as read-in is smaller than the first threshold value (Th1), that is if the picture quality is not deteriorated as compared to the preset reference value, the frame rate calculating unit 16 compares the magnitude of the quantization scale as read-in to a second threshold value (Th2) to see which is larger (step S5). The second threshold value (Th2) is set to a value lower than the first threshold value Th1. The second threshold value (Th2) is a value indicating the lower limit reference value of the degree of deterioration of the picture quality. That is, the second threshold value (Th2) is a reference value testifying to a sufficiently good picture quality, such that, as from this value, more emphasis is to be placed on picture continuity rather than picture quality. With MPEG-4, the quantization scale assumes a value of from 1 to 31, while the second threshold value (Th2) is set to a value such as “10”.

When the quantization scale as read-in is not larger than the second threshold value (Th2), that is when the picture quality is higher than the preset reference value, the frame rate calculating unit 16 decrements the index i by one (step S6). That is, the frame rate is increased by one step. If, when the frame rate is increased in this manner, the bit rate is not changed, the amount of the bits allocated to one frame is also decreased. Although the picture quality is deteriorated in this case, the picture continuity is improved.

If, in the steps S6 and S7, the index i is updated, the frame rate calculating unit 16 acquires the target frame rate X, corresponding to the index i, by referring to the table shown in FIG. 4, and transmits the so acquired target frame rate value X to the frame rate conversion unit 11 to update the frame rate set in the frame rate conversion unit 11 (step S9). The frame rate conversion unit 11 converts the frame rate of the input moving picture data from the camera device 2 into the transmitted target frame rate X.

If, as a result of decision in the step S7, the quantization scale (q_scale) as read-in is larger than the second threshold value Th2, or if the transmission at the frame rate of step S9 is finished, the frame rate calculating unit 16 reverts to the step S3 to carry out the processing as from this step S3 from one frame to another.

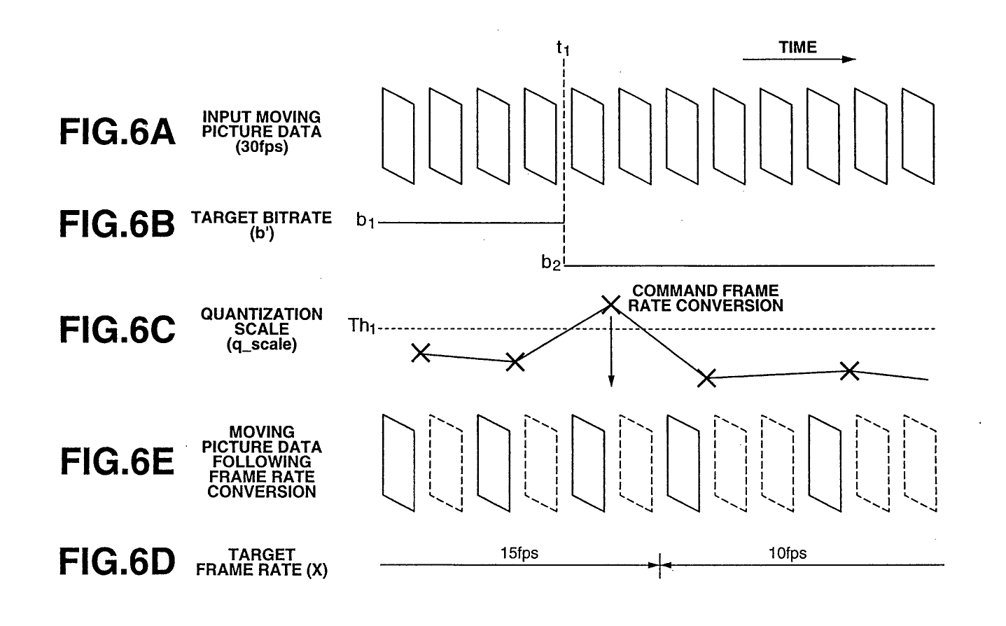

FIG. 6 shows a typical concrete processing operation of the transmission device 3 in case of carrying out the frame rate control processing as described above.

FIG. 6A shows moving picture data input to the transmission device 3. FIG. 6B shows the target bitrate b′ as set by the target rate calculating unit 15. FIG. 6C shows the quantization scale as detected by the frame rate calculating unit 16. FIG. 6D shows the target frame rate X output from the frame rate calculating unit 16. FIG. 6E shows moving picture data after the frame rate has been converted by the frame rate conversion unit 11.

Referring to FIG. 6, the state of communication over the IP network 5 is good, up to a certain optional time point t1. The MPEG-4 datastream is generated at an optional target bitrate b1, with the frame rate being 15 fps.

Assume that a decision has been given that the state of communication of the IP network 5 has become aggravated at the optional time t1. The target rate calculating unit 15 then lowers the target bitrate to (b2<b1). As the target bit rate has been lowered, the quantization scale of the frame encoded directly after time t1 is increased. If, at this time, the quantization scale is not less than the first threshold value Th1, the frame rate calculating unit 16 issues a command for changing the frame rate as from the next frame. As a result, the frame rate is decreased by one step to 10 fps.

In the real time picture data distributing system of the present embodiment of the present invention, described above, the bitrate of the MPEG-4 datastream is controlled depending on the target bitrate as determined by the state of the IP network 5, and the MPEG-4 datastream, the bitrate of which has been controlled, is transmitted to the IP network 5.

Moreover, in the real time picture data distributing system of the present embodiment of the present invention, described above, the frame rate of the moving picture data encoded for compression is changed in dependence on the degree of deterioration of the picture quality of the moving picture data encoded in the MPEG-4 datastream. Specifically, when the degree of deterioration of the picture quality of the MPEG-4 datastream, generated by the moving picture encoding unit 12, has become larger than the first threshold value Th1, the setting value for the frame rate is changed to a value lower than the current value. By so doing, the moving picture data can be distributed in real-time, without deteriorating the picture quality to more than a preset amount, even if the state of communication of the moving picture data is aggravated. On the other hand, when the degree of deterioration of the picture quality of the MPEG-4 datastream, generated by the moving picture encoding unit 12, has become smaller than the second threshold value Th2, the setting value of the frame rate is changed to a value higher than the current value. By so doing, the moving picture data, improved in picture continuity, may be distributed in real-time, when the state of communication on the IP network 5 is improved, such that a sufficient picture quality may be achieved.

In the above case, the quantization scale is detected as a parameter by which to verify the degree of deterioration of the picture quality of the MPEG-4 datastream. It is however possible to use, as the degree of deterioration of the picture quality, the S/N ratio (signal/noise ratio) of the moving picture data following encoding to the MPEG-4 datastream.

That is, in case the S/N ratio of the frame after encoding has become not higher than the preset first threshold value, the frame rate is lowered under the assumption that the deterioration of the picture quality has exceeded a reference value, whereas, in case the S/N ratio of the frame after encoding has become not less than the preset second threshold value which is higher than the first threshold value, it is determined that the picture quality is sufficiently good and the frame rate is increased. However, the S/N ratio and the subjective picture quality are not necessarily coincident with each other, depending on the features of the input picture. It is therefore desirable to correct the S/N valueio using parameters representing characteristics of a picture, such as activity. That is, even with a picture representing subjectively similar picture quality deterioration, but with a low activity, that is a picture having flat portions, the S/N ratio tends to be higher, whereas, with the same picture with a high activity, that is a picture having many complex portions, the S/N ratio tends to be lower. It is therefore desirable that the S/N ratio in a picture with a low activity and that in a picture with a high activity are corrected to be low and high, respectively.

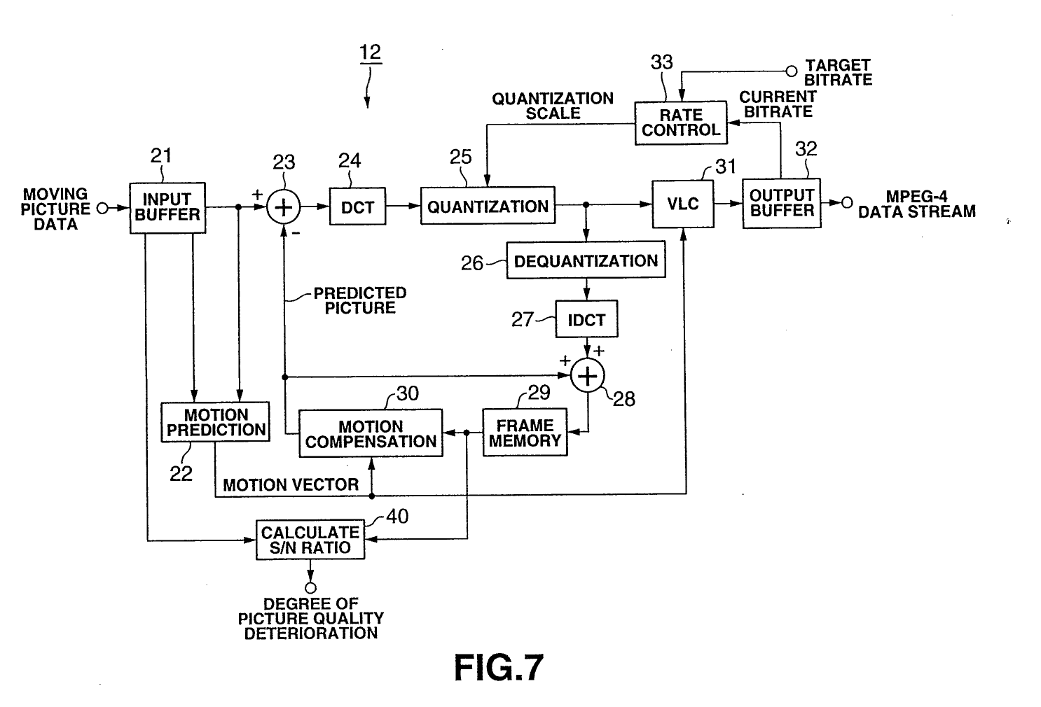

In verifying the degree of deterioration of the picture quality from the S/N ratio, it: is sufficient to provide an S/N ratio calculating circuit 40 in the moving picture encoding unit 12, as shown for example in FIG. 7.

The S/N ratio calculating circuit 40 finds the S/N ratio as follows:

First, the S/N ratio calculating circuit 40 finds, based on a pixel value f(i, j) of an input picture stored in the input buffer 21 and a pixel value g(i,j) of an encoded and subsequently decoded picture stored in the frame memory 29, an error d, in accordance with the following equation (2): [symbol]
(2)
where i is a pixel position in the horizontal direction within a frame and j is a pixel position in the vertical direction in the frame.

The S/N ratio calculating circuit 40 then finds, from the error d, thus obtained, the S/N ratio in accordance with the following equation (3): [symbol]
(3)

The error d may also be calculated, using, instead of the square sum as shown in the equation (2), the sum of absolute values, as indicated by the following equation (4): [symbol]
(4)

With use of the sum of absolute values, the S/N ratio may be found in accordance with the following equation (5): [symbol]
(5).

Meanwhile, in calculating the S/N ratio from the error d, logarithmic calculations are needed, thus increasing the processing volume. Since the S/N ratio is a monotonously decreasing function with respect to the error d, it may be the error d, instead of the S/N ratio, that is output.

1. An apparatus for encoding a moving picture comprising:
frame rate controlling means for controlling the frame rate of an input moving picture datastream, composed of a plurality of chronologically arrayed frames;
frame rate calculating means for calculating a setting value of the frame rate of said moving picture datastream; and
encoding means for encoding said moving picture datastream, output from said frame rate controlling means, for compression, and for outputting an encoded datastream, generated on said encoding for compression;
said encoding means controlling the bitrate of said encoded datastream in dependence on a target bitrate as set from outside;
said frame rate calculating means calculating a setting value of the frame rate based on the picture quality of said encoded datastream output from said encoding means;
said frame rate controlling means controlling the frame rate of said moving picture datastream to a setting value calculated by said frame rate calculating means.

2. The apparatus for encoding a moving picture according to claim 1 wherein said frame rate calculating means changes the setting value of the frame rate to a value lower than the current value when the degree of deterioration of the picture quality of the datastream encoded by said encoding means is not less than a preset value.

3. The apparatus for encoding a moving picture according to claim 1 wherein said frame rate calculating means changes the setting value of the frame rate to a value higher than the current value when the degree of deterioration of the picture quality of the datastream encoded by said encoding means is not larger than a preset value.

4. The apparatus for encoding a moving picture according to claim 1 wherein said frame rate calculating means changes the setting value of the frame rate to a value lower than the current value when the degree of deterioration of the picture quality of the datastream encoded by said encoding means is not less than a first threshold value and wherein said frame rate calculating means changes the setting value of the frame rate to a value higher than the current value when the degree of deterioration of the picture quality of the datastream encoded by said encoding means is not larger than a second threshold value lower than said first threshold value.

5. The apparatus for encoding a moving picture according to claim 1 wherein said encoding means encodes said moving picture datastream for compression by quantizing data based on a quantization scale value, and wherein said frame rate calculating means verifies the picture quality of the encoded datastream output from said encoding means based on said quantization scale value.

6. The apparatus for encoding a moving picture according to claim 1 further comprising:
S/N (signal/noise) ratio calculating means for calculating an S/N ratio of the encoded datastream based on a pixel value of the moving picture datastream prior to encoding and on a pixel value of the moving picture datastream following the decoding of said encoded datastream;
said frame rate calculating means verifying the picture quality of the encoded datastream, output by said encoding means, based on said S/N ratio.

7. An apparatus for encoding a moving picture in which an encoded datastream is generated by encoding a moving picture datastream, formed by pixel data in a spatial domain, for compression, said apparatus comprising:
orthogonal transform means for orthogonal transforming pixel data of said moving picture datastream, in terms of a preset pixel block as a unit, to generate a moving picture datastream, composed of pixel data in the frequency domain;
quantization means for quantizing the moving picture stream, composed of pixel data of the frequency domain output from said orthogonal transform means, based on the quantization scale set from one said preset pixel block to another;
encoding means for converting the moving picture datastream, quantized by said quantization means, into an encoded datastream which is in keeping with a preset encoding system, to output the resulting encoded datastream;
inverse quantization means for inverse quantizing the moving picture datastream, quantized by said quantization means, based on the quantization scale used at the time of quantization;
inverse orthogonal transform means for inverse orthogonal transforming the moving picture datastream, inverse quantized by said inverse quantization means, in terms of a preset pixel block as a unit, to generate a moving picture datastream formed by pixel data in the spatial domain; and
S/N (signal/noise) ratio calculating means for finding the S/N ratio based on pixel data of the original moving picture datastream supplied to said orthogonal transform means and pixel data of the encoded moving picture datastream output from said inverse orthogonal transform means.

8. A method for encoding a moving picture in which an input moving picture datastream, composed of a plurality of chronologically arrayed frames, is encoded for compression to generate an encoded datastream, said method comprising:
encoding said datastream for compression, as the bitrate of the encoded datastream to be output is controlled in keeping with a setting value of the target bitrate; and
detecting the picture quality of the generated encoded datastream and calculating a setting value of the frame rate based on the detected picture quality, by way of controlling the frame rate of said moving picture datastream.

9. An apparatus for transmitting a moving picture comprising:
frame rate controlling means for controlling the frame rate of an input moving picture datastream composed of a plurality of chronologically arrayed frames;
frame rate calculating means for calculating a setting value of the frame rate of said moving picture datastream;
encoding means for encoding said moving picture datastream, output from said frame rate controlling means, for compression, and for outputting an encoded datastream, generated on said encoding for compression; and
transmitting/receiving means for transmitting the datastream, encoded by said encoding means, to a receiving apparatus over a network, and transmitting/receiving control data with said receiving apparatus;
said transmitting/receiving means detecting the state of the network based on control data received by said receiving apparatus and calculating a target bitrate based on the detected network status;
said encoding means controlling the bitrate of said encoded datastream responsive to the target bitrate calculated by said transmitting/receiving means;
said frame rate calculating means calculating the setting value of the frame rate based on the picture quality of the encoded datastream output from said encoding means;
said frame rate controlling means controlling the frame rate of said moving picture datastream to the setting value calculated by said frame rate calculating means.
